(19) United States
(12) Patent Application Publication
(10) Pub. No.: US 2008/0025730 A1
(43) Pub. Date: Jan. 31, 2008

(54) Method and apparatus for autonomous adaptation of an optical dispersion compensation ("ODC") module

(76) Inventors: Thomas J. Giovannini, San Jose, CA (US); Anthony L. Chun, Los Altos, CA (US); Andrew Daiber, Emerald Hills, CA (US); Jan Peeters Weem, Hillsboro, OR (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/479,325

(22) Filed: Jun. 29, 2006

(51) Int. Cl. H04B 10/12

(52) U.S. Cl. 398/147; 398/81

(57) ABSTRACT

Optical transponders incorporating an optical dispersion compensator (“ODC”) to perform an adjustable, frequency dependent correction of an optical signal are described and claimed. The ODC is adjusted by a feedback controller that responds to information from at least one signal analyzer. Systems using similar ODC-equipped optical transponders are also described and claimed.

### FIELD

The invention relates to optical signal processing. More specifically, the invention relates to control systems to improve the quality of an optical signal.

### BACKGROUND

Computers, data processing systems and communication systems have come to rely increasingly on digital data communication networks. The demand for fast, reliable data transfer services is increasing steadily. Optical data links, which transmit data by modulating a laser, may permit higher signaling rates and greater communication distances than corresponding electrical systems. However, most transmitters and receivers (end devices) operate with electrical signals, not optical signals, so signal conversions are usually required. Also, the range of signal processing functions that can be performed in the optical domain is smaller than the range of processing that can be performed on a comparable electrical signal. As new devices and techniques for manipulating optical signals become available, they can be incorporated into communication systems to improve the systems' performance.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows an overview of an environment where an embodiment of the invention may be used.

FIGS. 2A-2D show aspects of data encoding, transmission distortion, and signal recovery.

FIG. 3 is a high-level flow chart of operations of an embodiment.

FIG. 4 is a block diagram of a hardware system.

FIGS. 5A-5C show several different embodiments of the invention.

FIG. 6 explains the operation of the embodiment of FIG. 5A.

FIG. 7 explains the operation of the embodiment of FIG. 5C.

### DETAILED DESCRIPTION

Embodiments of the invention use a tunable optical dispersion compensation (“ODC”) device to precondition a received optical signal to improve the signal-to-noise (“S/N”) ratio and data-carrying capacity of the signal. By monitoring the signal in real-time, an embodiment can autonomously adapt to changing optical transmission conditions and maintain a robust communication link. Information that can be extracted from the signal without knowledge of the data being carried by the signal permits adaptation without requiring feedback from later stages in the signal transmission system, when interfaces to obtain such feedback may be absent or difficult to implement.

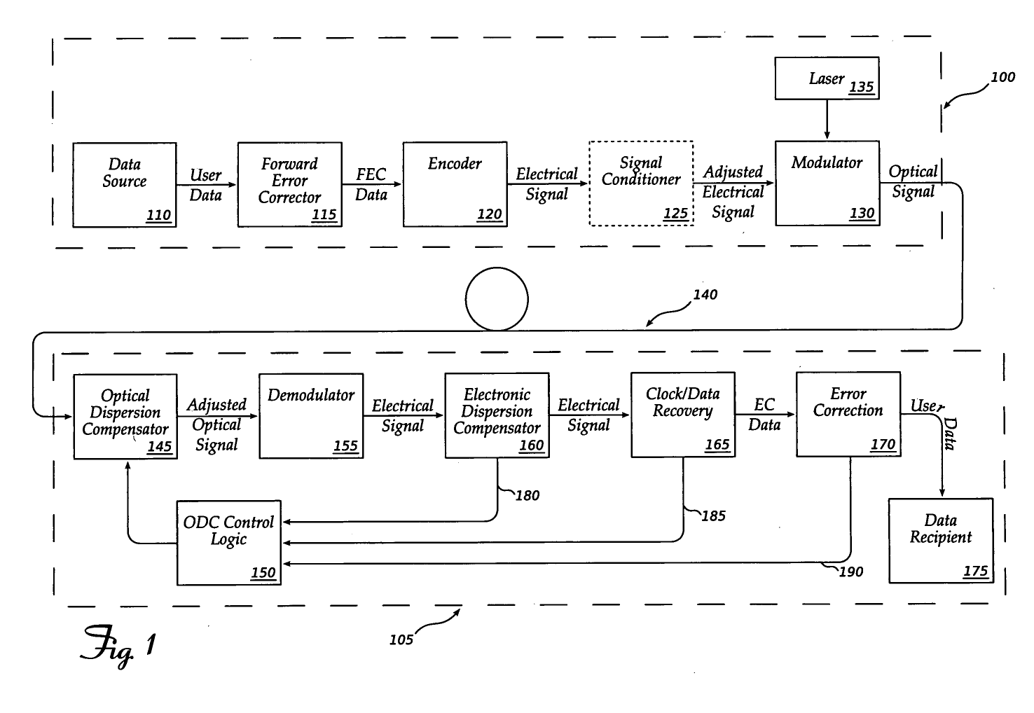

FIG. 1 shows an overview of an environment where an embodiment of the invention can operate. A transmitting station 100 and receiving station 105 are connected by a transmission medium 140 such as a fiber optic cable or a free-air transmission path. At the transmitting station 100, a data source 110 produces data that is to be sent to the receiver. The data is augmented with error correction information such as checksums or cyclic redundancy check (“CRC”) digits by forward error corrector (“FEC”) 115, then encoded by encoder 120 to produce an electrical signal carrying the FEC data. Encoding methods such as non return to zero (“NRZ”) or duobinary (“DB”) may be used in some embodiments.

The electrical signal from encoder 120 may be adjusted by signal conditioner 125, then the (possibly adjusted) signal is provided to modulator 130, which modulates light from laser 135 to produce an optical signal that carries the user data. The optical signal travels through transmission medium 140 to receiving station 105.

At the receiver, an optical dispersion compensator (“ODC”) 145 is used to correct for linear-delay dispersion introduced into the optical signal by the transmission medium 140. ODC 145 performs an adjustable, linear-delay dispersion correction of the optical signal based on a control signal provided by ODC control logic 150. The adjusted optical signal is passed to demodulator 155, which converts the optical signal to an electrical signal. The electrical signal may be further corrected to improve its signal-to-noise (“S/N”) ratio by electronic dispersion compensator (“EDC”) 160, and the cleaned signal may be analyzed to recover the user and error correction data by clock/data recovery unit 165. The error correction data is extracted and applied by error correction unit 170, and finally the original user data is passed to a recipient 175. ODC control logic 150 may incorporate error signals or other signal metrics produced by signal analyzers such as electronic dispersion compensator 160, clock/data recovery unit 165, and/or error correction unit 170 into its control signal to adjust the optical dispersion compensation action of ODC 145. A second, similar set of modules may be provided in a system to permit the receiving station to send data back to the transmitting station. Of course, this second set of modules would be arranged backwards from the sequence shown in FIG. 1.

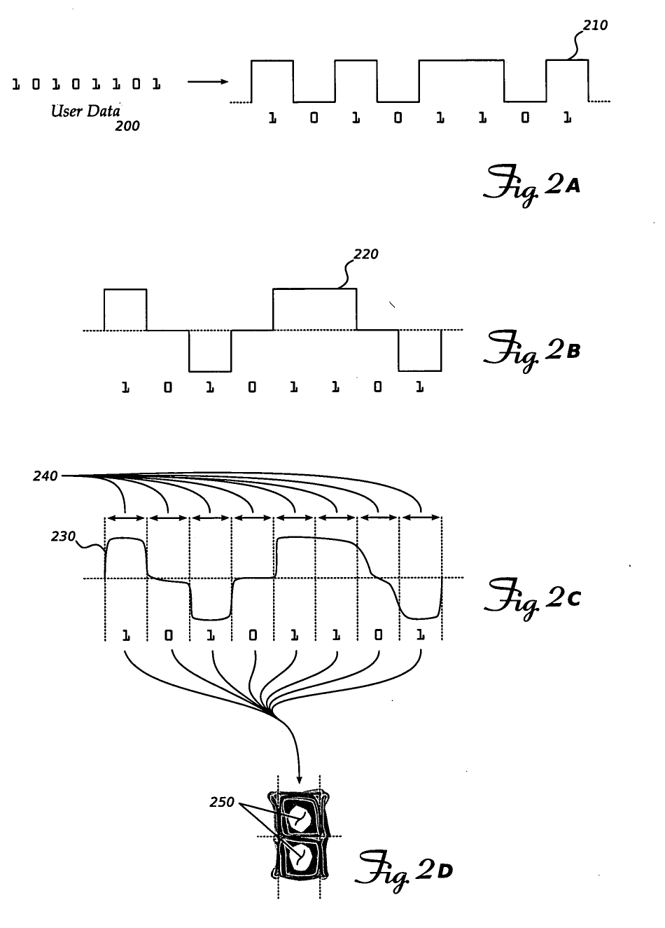

FIGS. 2A-2D show some relevant aspects of data conversion and transmission. In FIG. 2A, user data 200 (an eight-bit binary value 10101101) is converted to a serial signal 210. FIG. 2B shows the same signal encoded as duobinary 220. (In a practical system, error correction bits and other serial-transmission control bits may have been added to the serial signal; these bits are omitted here.) FIG. 2C shows how the signal may appear at the input of the receiver after transmission across a channel. Distortion and filtering effects of the channel alter the propagation characteristics of different frequency components of the signal, resulting in rounded edges, premature or late signal transitions, and similar unwanted artifacts (generally, linear delay dispersion and additive white Gaussian noise (“AWGN”)). If the nominal bit times 240 of received signal 230 are superimposed, a signal plot like FIG. 2D may be prepared. The gray areas of the plot show where some signal traces pass, while white areas 250 are the “eyes” of the signal, representing threshold level margins and timing margins that may be used to distinguish received signal levels. Noise, timing inconsistencies, and other distortions from the transmitter, transmission channel, and receiver, reduce the signal-to-noise ratio of the signal and close the eyes, making it more difficult to recover the original signal correctly.

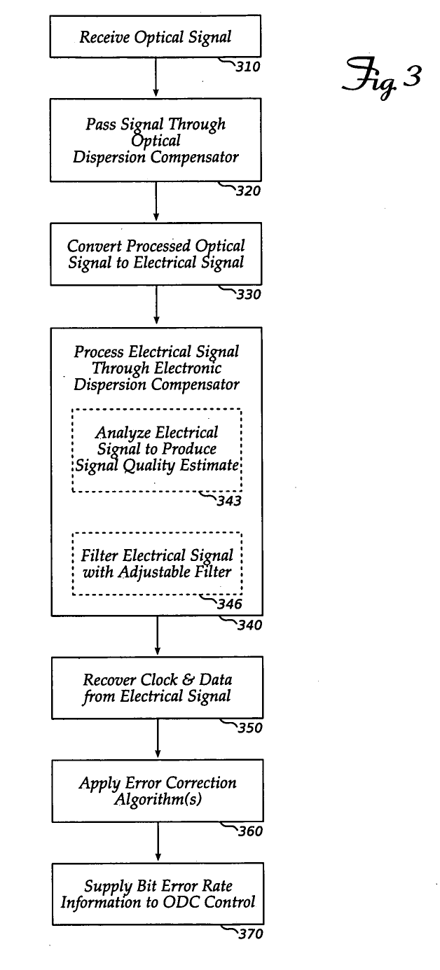

An embodiment of the invention uses an optical dispersion compensator (“ODC”) to pre-condition a received optical signal and “clean up” or “open the eyes” of the signal to improve subsequent processing results. FIG. 3 describes this process.

First, an optical signal carried from a source through a transmission medium is received (310). The signal is passed through an ODC, which delays components of the signal by a time that varies according to the light frequency (color) of the optical signal spectrum and according to a control signal (320). The ODC is operated to counteract some of the distortions introduced by transmission of the signal through the transmission medium. The ODC-processed optical signal is converted to an electrical signal (330) by a demodulator such as an avalanche photodiode (“APD”) or a PIN diode (“PIN” stands for “positive-intrinsic-negative,” referring to the doping of a semiconductor material). The electrical signal may be further processed by an electronic dispersion compensator (“EDC”) circuit (340), which counteracts or compensates for other signal distortions. The EDC may analyze the electrical signal to produce signal quality estimate (343) and/or filter the electrical signal with an adjustable filter controlled by a second control signal (346). Clock and data signals may be recovered from the resulting electrical signal (350), and an error correction algorithm may be applied to the recovered data (360). An error correction module may produce a bit error rate indication (370) that can be incorporated into an ODC feedback control loop that produces the ODC control signal.

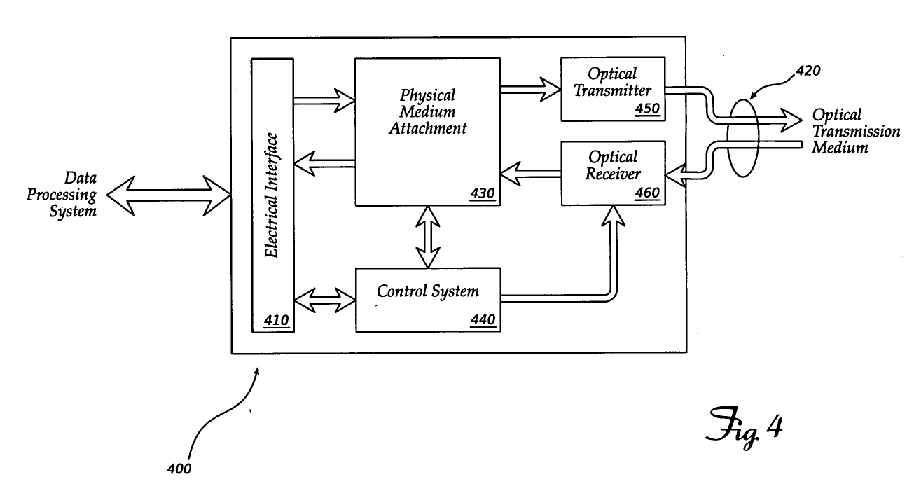

FIG. 4 shows a block diagram of an optical transceiver 400 that incorporates an optical dispersion compensator (not shown in this Figure) in the receiving path to autonomously adapt to signal distortions introduced by conditions on the optical transmission medium. The transceiver may be packaged according to one of the common mechanical dimension form factors described in a series of Multi-Source Agreements (“MSAs”) that help ensure compatibility and interchangeability of modules from different manufacturers. A standard electrical interface 410 such as a 300-pin MSA or a board-edge connector permits the module to exchange control signals and data with a data processing system, and an optical interface 420 permits the module to connected to a transmission medium so that it can communicate with another transceiver similarly connected. Note that the electrical interface may dictate specific functions for most or all of the connectors used in the interface. Consequently, it may not be possible to allocate new signal lines to carry new or different information between the transceiver and its surrounding system. However, many specifications include a modest bandwidth data channel that can be used to exchange arbitrary information between a transceiver and its host. For example, some electrical interfaces include an inter-integrated circuit (“I2C”) serial channel. This channel can carry information about system-performed data processing back to a control processor in the transceiver.

Physical medium attachment (“PMA”) module 430 contains the core electrical functionality of transceiver 400. Functions performed here include multiplexing and demultiplexing data streams (serial-to-parallel and parallel-to-serial); data encoding for transmission; electronic dispersion compensation; and clock/data recovery from a received signal. Control system 440 is generally implemented with a programmable microprocessor or microcontroller. Controller software or firmware routines permit the transceiver to adapt to changing line conditions, to monitor and control physical parameters such as transmitter power and temperature; and to respond to control and status requests from applications on the data processing system.

Optical transmitter 450 may include a laser and modulator to produce the optical signal that is transmitted through the outbound side of optical interface 420, while optical receiver 460 includes an optical dispersion compensator (“ODC”) to correct the received optical signal and an APD or PIN diode to convert the corrected optical signal to an electrical signal.

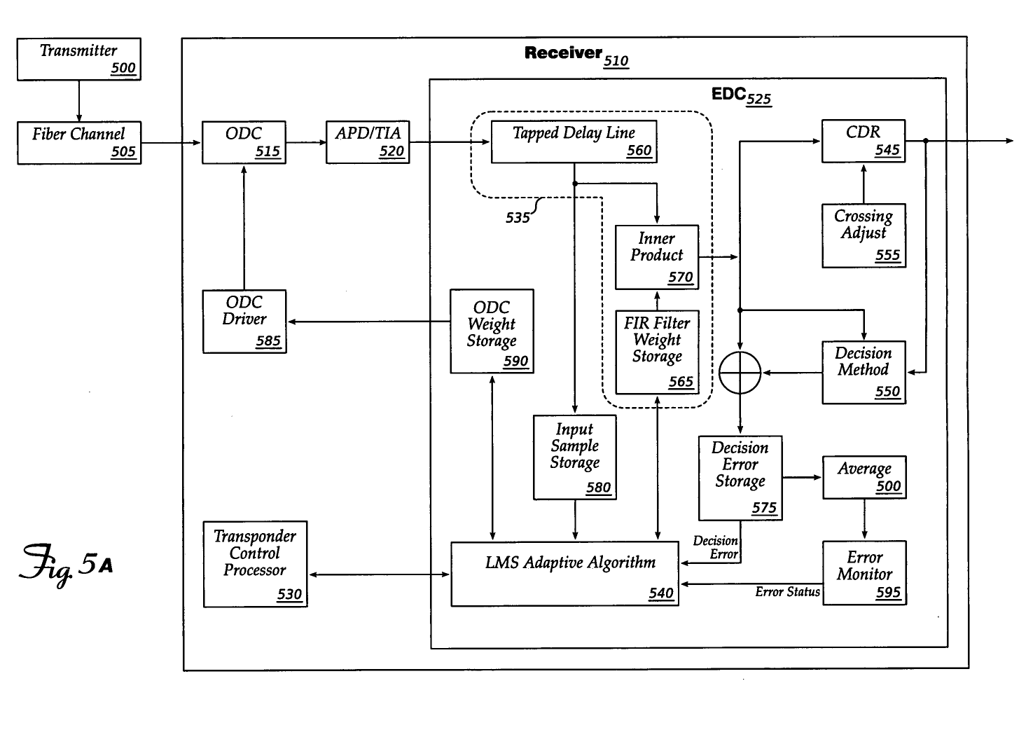

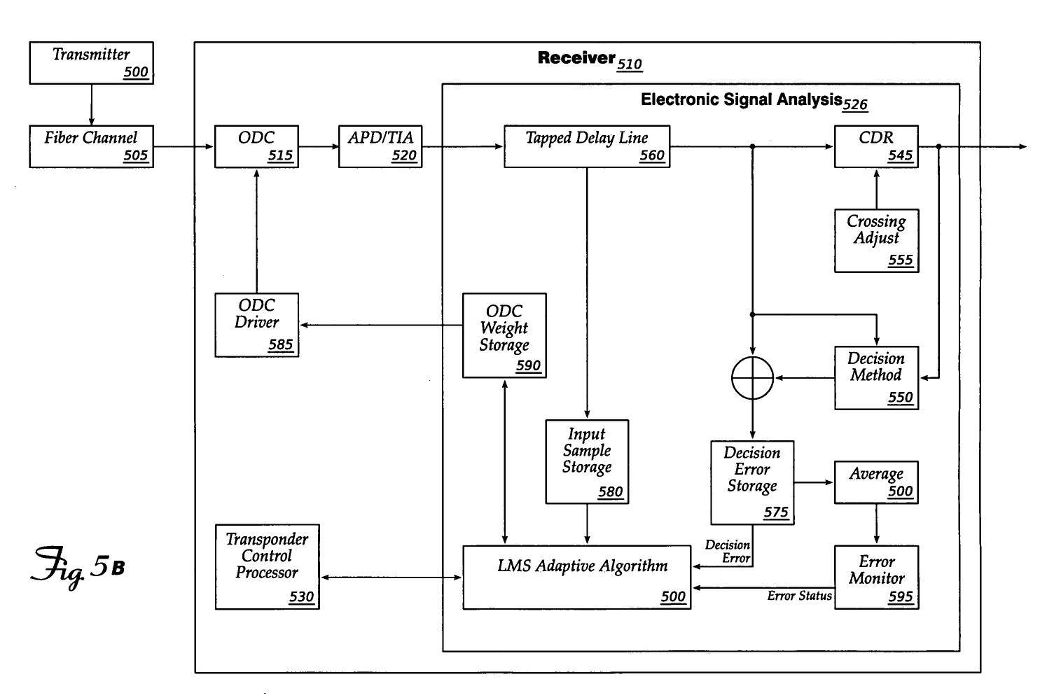

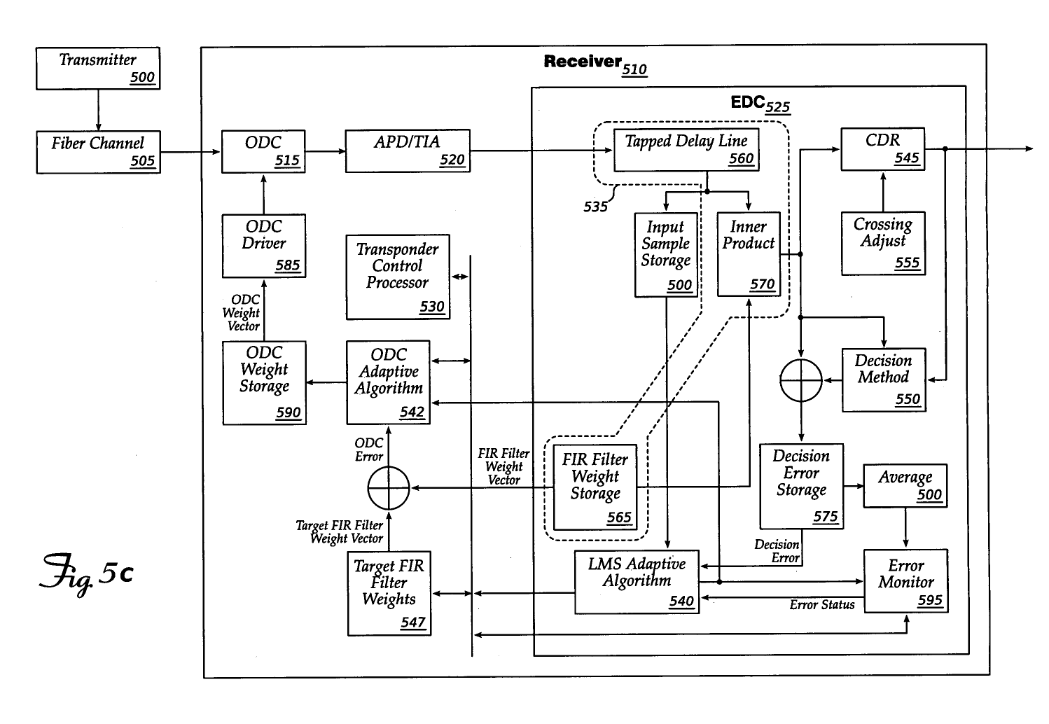

FIGS. 5A-5C focus on control loop operations involving portions of the physical medium attachment (and specifically the electronic dispersion compensator) and the optical dispersion compensator in the optical receive path, as directed by the control system according to embodiments of the invention. The three embodiments shown in these figures represent different tradeoffs between complexity and performance. Each embodiment can be implemented within a Dense Wavelength Division Multiplexing (“DWDM”) optical transponder module that communicates with a peer module through a single-mode optical fiber, and requires no interaction with an external Forward Error Correction (“FEC”) chip on a host line card for ODC module adaptation (although feedback from a FEC may be incorporated into the control system if it is available). Each embodiment can be applied to either non-return to zero (“NRZ”) or duobinary (“DB”) signal formats since, after optical to electrical conversion, the received signal is a two-level signal in both cases.

In FIG. 5A, the transmitter 500 is assumed to modulate laser light in the form of non-return-to-zero (NRZ) or duo-binary (DB) formats. The fiber channel 505 is assumed to introduce linear-delay dispersion and additive white Gaussian noise (“AWGN”). The receiver 510 includes an ODC module 515, an APD/TIA module 520 that performs optical to electrical conversion (alternatively, a PIN diode could be used), an electronic dispersion compensation (“EDC”) module 525 and a transponder control processor (microprocessor) 530.

The EDC module 525 provides adaptation of a finite-impulse response (“FIR”) filter 535 using the least-mean-square (“LMS”) adaptation algorithm 540, and adaptation of the ODC module 515 via the same LMS adaptation algorithm 540. Symbol decision and timing recovery are performed by clock/data recovery (“CDR”) module 545 and decision method 550. Crossing adjust module 555 tunes the CDR module's decision point. The transponder microprocessor 530 controls the initiation of the LMS adaptation algorithm 540 and monitors the operation and status of the transponder.

The FIR filter 535 includes an analog tapped delay line (“TDL”) 560, a FIR filter coefficient, or “weight,” storage block 565 and an inner-product block 570. Some embodiments may use a sampling front-end and a digital tapped delay line in the place of analog TDL 560. The TDL 560 receives its input from the APD/TIA module 520. It propagates its input along a series of daisy-chained delay elements (not shown). Each delay element, or “tap,” has approximately the same incremental delay, which may be a fraction of the bit period. At any one instant of time, the values at the tap outputs represent the input sample vector. At any one instant of time, the inner-product block 570 computes the output of the FIR filter 535 by forming the inner product between the input sample vector from the TDL and the FIR filter weight vector from the FIR filter weight storage block 565.

The clock-data recovery block 545 uses the symbol estimate at the output of the FIR filter to form the symbol decision. It also provides symbol-rate timing synchronization for the LMS adaptation process which operates at the symbol rate (or a sub-multiple of the symbol rate). During the adaptation process, the input crossing of the CDR is assumed to be fixed at 50%, although it may also be optimized by user control through crossing adjust 555.

The decision method block 550 is assumed to provide both blind and decision-directed adaptation error criteria (as described below). At each symbol period, a decision error is formed from the difference between the current symbol estimate from the output of the FIR filter 535 and the current symbol decision from the decision method block 550. At the end of each symbol period, the decision error storage block 575 is updated with the new decision error. Simultaneously, the input sample storage block 580 is updated with the input sample vector that corresponds to the decision error stored in the decision error storage block 575. It is assumed that any latency through the CDR 545 and decision method block 550 is compensated for when updating the input sample storage block 580.

The LMS adaptation algorithm 540 is driven by the decision error from the decision error storage block 575. During each weight update iteration, the LMS adaptation algorithm 540 uses the current decision error from the decision error storage block 575, the current input sample vector from the input sample storage block 580 and the current FIR filter weight vector from the FIR filter weight storage block 565 to compute a new FIR filter weight vector. At the end of each LMS adaptation algorithm iteration, the FIR filter weight storage block 565 is updated with the new FIR filter weight vector. The LMS adaptation algorithm 540 updates the FIR filter weight vector using the equation:

W̅_{FIR}_{ₖ₊₁}= W̅_{FIR}_{ₖ}+2μεₖ X̅ₖ Eq. 1

where X̅ₖ is the input sample vector from the input sample storage block at iteration k, W̅_{FIR}_{ₖ} is the FIR filter weight vector from the FIR filter weight storage block at iteration k, εₖ is the decision error from the decision error storage block at iteration k, μ is a constant that controls convergence and stability and W̅_{FIR}_{ₖ₊₁} is the new FIR filter weight vector. To simplify the nomenclature in the following discussion, X̅ₖ, W̅ₖ and W̅ₖ₊₁ are assumed to be row vectors of equal dimension. For decision-directed adaptation, the decision error is expressed as:

εₖ=dₖ−yₖ Eq. 2

where yₖ is the symbol estimate from the output of FIR filter at iteration, k, and dₖ is the symbol decision from the decision method block at iteration, k (which in this case is passed directly through the decision method block). For blind adaptation, the decision error can be expressed as

$${ɛ}_{k} = \frac{{y}_{k}}{‖ {y}_{k} ‖} - {y}_{k} \qquad Eq . 3$$

where the decision error method block provides a normalized version of the symbol estimate,

$$\frac{{y}_{k}}{‖ {y}_{k} ‖} ,$$

to be used as the symbol decision. In this case, the LMS adaptation algorithm is transformed into a constant-modulus algorithm (“CMA”). CMA can be used to initially adapt the weights to a state where the equalized signal eye is sufficiently open to switch to decision-directed adaptation.

The linear-delay dispersion of the ODC module 515 is controlled by the ODC driver module 585 that is driven by an ODC weight vector from the EDC module 525. The LMS adaptation algorithm 540 in the EDC module 525 also updates the ODC filter weight vector using the equation

W̅_{ODC}_{ₖ₊₁}= W̅_{ODC}ₖ+2μεₖ X̅ₖ Eq. 4

where X̅ₖ is the input sample vector from the input sample storage block at iteration, k, W̅_{ODC}_{ₖ} is the ODC weight vector from the ODC weight storage block 590 at iteration, k, εₖ is the decision error signal from the decision error storage block at iteration, k, μ is a constant that controls convergence and stability and W̅_{ODC}_{ₖ₊₁} is the new ODC weight vector. At the end of each LMS adaptation algorithm iteration, the ODC weight storage block 590 is updated with the new ODC weight vector. The dimension of W̅_{ODC}_{ₖ} is assumed to be less than or equal to the dimension of W̅_{FIR}_{ₖ}. If the dimension of W̅hd ODC_{ₖ} is less than the dimension of W̅_{FIR}_{ₖ}, a subset of X̅ₖ that has dimension equal to W̅_{ODC}_{ₖ} is used to compute W̅_{ODC}_{ₖ₊₁}. Let this new input sample vector be represented as X̅′ₖ. X̅′ₖ is assumed to be formed from a contiguous subset of the elements of X̅ₖ. Ideally, this subset of elements is centered around the element of X̅ₖ that corresponds to the largest element of W̅_{FIR}_{ₖ}.

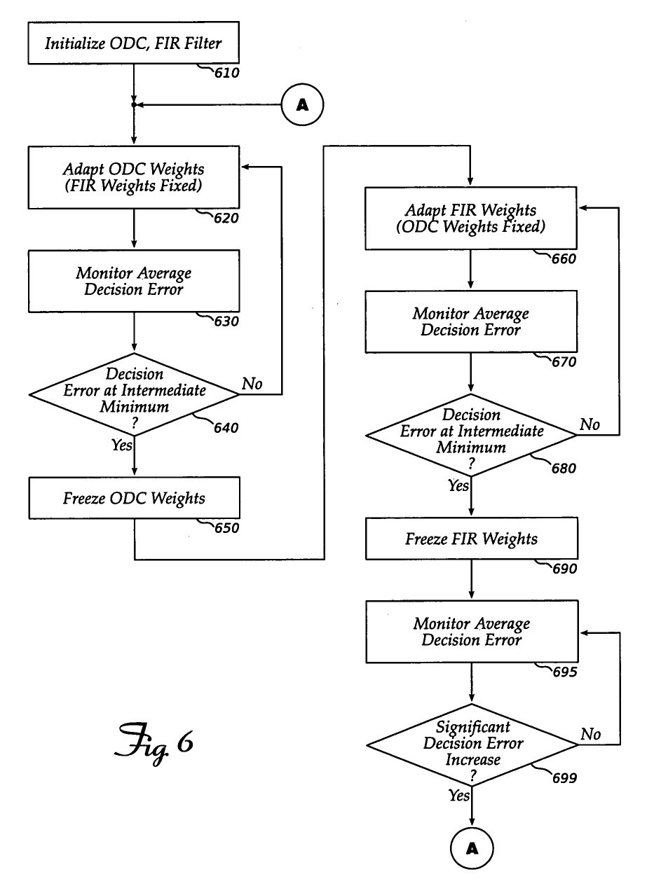

The autonomous adaptation process for the fiber channel proceeds as shown in FIG. 6:

First, the ODC and FIR filter are initialized (610). Given a priori knowledge of approximate characteristics of a transmission medium such as the fiber channel length, the ODC weight vector can be initialized such that the ODC module's linear-dispersion slope is a value that approximately compensates for the fiber channel's linear dispersion. If apriori knowledge of the approximate characteristics is not available, the ODC weight vector may be initialized so that that the ODC module has zero-dispersion slope. The FIR filter weight vector's center weight is also initialized with a single impulse weight and all other weights are set to zero.

Next, the LMS adaptation algorithm is allowed to adapt the ODC weights, keeping the FIR filter weights fixed to a single impulse (620). An error monitor module 595 monitors the average decision error (630). When it detects that the average decision error has reached an intermediate minimum (640), it signals the LMS adaptation algorithm to freeze the latest ODC weights (650) and then begins adapting the FIR filter weights (660). The frozen ODC weights are considered optimum weights. The error monitor module again monitors the average decision error as the FIR filter weights are varied (670). When it detects that the average decision error has reached a minimum (680), it signals the LMS adaptation algorithm to freeze the latest FIR filter weights (690). The frozen FIR filter weights are considered optimum weights. Now, the LMS adaptation algorithm stops the adaptation process and the system operates at the optimum ODC and FIR weights.

The error monitor module continues to monitor the average decision error (695). If it detects that the average decision error has deviated significantly from the minimum obtained with the optimum weights determined above (699), it restarts the adaptive process, starting with the current ODC and FIR filter weights, and a new optimum weight set is obtained.

Ideally, the final ODC weights should set the ODC module's linear-dispersion slope to the negative of the transmission medium's linear dispersion slope, and the final FIR filter weights should represent the optimum filter response that essentially compensates for inter-symbol interference distortion caused by any non-optimum received pulse shape characteristics that result from the overall response of the transmitter/ODC/APD/TIA sequence. In general, the FIR filter weights may play a role in compensating any residual linear-delay dispersion.

The embodiment shown in FIG. 5A and described with reference to FIG. 6 takes advantage of both ODC and EDC to provide robust reach extension performance. The ODC module provides the bulk of the linear-delay dispersion capability, thus allowing the EDC module to be of reduced complexity. The EDC module provides pulse shaping capability for optimum receiver performance, as well as compensation for residual linear-delay dispersion. Another favorable characteristic of this embodiment is that the ODC and EDC modules are adapted using the same LMS algorithm.

FIG. 5B shows an architectural view of a second embodiment. It is derived from the embodiment shown in FIG. 5A by removal of the FIR filter functionality 535 (only the tapped delay line 560 is retained).

The LMS adaptation algorithm updates the ODC filter weight vector using the equation

W̅_{ODC}_{ₖ₊₁}= W̅_{ODC}_{ₖ}+2μεₖ X̅ₖ Eq. 5

as described in paragraph [0028].

The autonomous adaptation process for the fiber channel in this embodiment proceeds largely the same as in shown in FIG. 6, but the FIR adaptation operations are omitted (because there is no FIR). This embodiment corrects as much signal distortion as possible using the ODC, but in general, the compensated signal at the output of the ODC module may contain residual linear-delay dispersion.

The embodiment shown in FIG. 5B is a simplified version of that shown in FIG. 5A. Its application would be in a scenario where the additional pulse shaping and residual linear-delay dispersion compensation capability from a FIR filter in an EDC module provide little or no additional reach extension performance. Replacing EDC 525 with the simpler electronic signal analysis module 526 may allow for power and chipset area savings.

FIG. 5C shows an architectural-view of a third embodiment. Like the embodiment depicted in FIG. 5A, the EDC module includes a FIR filter 535 whose filter weights are adapted using the LMS adaptation algorithm. The LMS adaptation adaptive process for the FIR filter is the same as described in paragraph [0027]. This embodiment is largely the same as the first, but some modules are shifted around to highlight the fact that transponders may be constructed based on existing EDC-only systems, and using existing components.

The linear-delay dispersion of the ODC module 515 is controlled by the ODC driver module 585 that is driven by the ODC weight vector in ODC weight storage 590 from the ODC adaptive algorithm 542. The ODC adaptive algorithm 542 is driven by an ODC error that is the difference between the current FIR filter weight vector from the EDC block 525 and a “target” FIR filter weight vector (to be described). The ODC adaptive algorithm 542 monitors the average decision error from the EDC block 525 to determine when it should process the ODC error to compute a new ODC weight vector. The transponder microprocessor 530 controls the initiation of the LMS and ODC adaptation algorithms, handles target FIR filter weight storage and monitors system status.

As described in paragraph [0027], the FIR filter's weight-update equation for the LMS adaptation algorithm is

W̅_{FIR}_{ₖ₊₁}= W̅_{FIR}_{ₖ}+2μεₖ X̅_{FIR}_{ₖ} Eq. 6

The ODC adaptation algorithm uses the ODC error to drive its adaptation process. The ODC error expressed as a row vector is

ε̅_{ODC}_{ⱼ}= W̅_{FIR}_{ⱼ}− W̅_{TARGET} Eq. 7

where W̅_{FIR}_{ⱼ} is the FIR filter weight vector from the FIR filter weight storage block at iteration j, and W̅_{TARGET} is the target FIR filter weight vector from the target FIR filter weight storage block. The ODC adaptation algorithm formulates a sum-of-squares objective function for the adaptive process from the ODC error as:

φ_{ODC}ₖ= ε̅_{ODC}ⱼ ε̅_{ODC}_{ⱼ}^{T} Eq. 8

where the superscript, T, signifies the transpose operation and ε̅_{ODC}_{ⱼ} is a row vector. The ODC adaptation algorithm applies an optimization algorithm to find the ODC weight vector that minimizes the objective function. At the end of each ODC adaptation algorithm iteration, the ODC weight storage block is updated with the new ODC weight vector.

The target FIR filter weight vector may be determined during a back-to-back calibration process using NRZ signaling. The target FIR filter weight vector is used as the “adaptation reference” for both NRZ and DB signaling. In the DB signaling case, the adaptive process during link operation will use the target FIR filter weight vector to drive the ODC module's linear-dispersion slope to provide an optimum NRZ signal eye at the receiver.

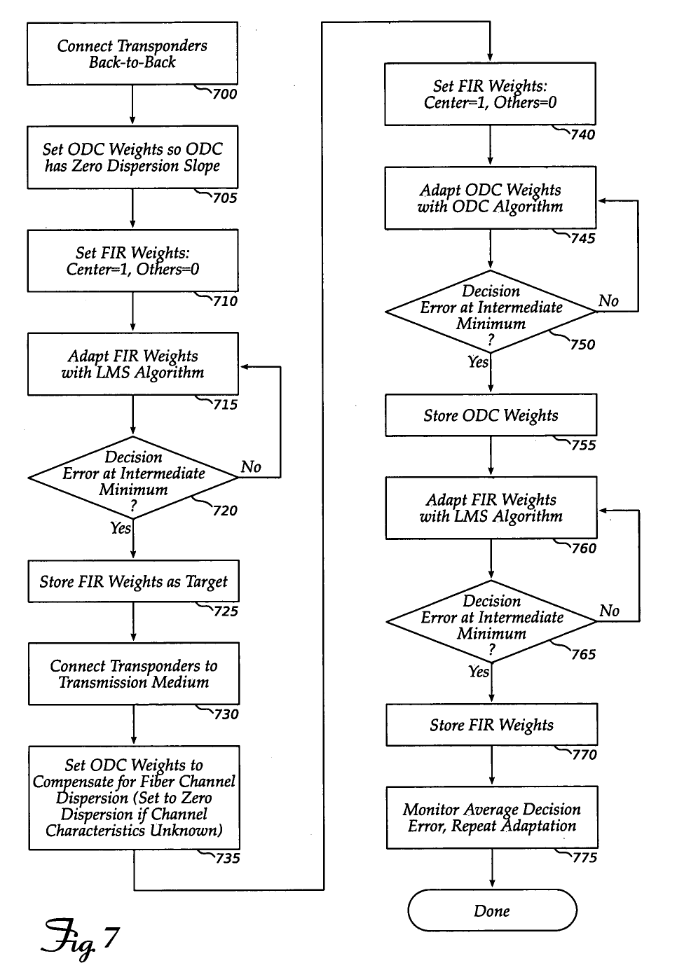

The calibration process is for the embodiment shown in FIG. 5C is explained in the flow chart of FIG. 7. The two transponders to be calibrated are connected using a back-to-back configuration that connects the transmitter directly to the receiver (700). The calibration process begins by first initializing the ODC weight vector so that the ODC module has zero-dispersion slope (705), and initializing the FIR filter's center weight with a single impulse weight and all other weights set to zero (710). The LMS adaptive algorithm is then allowed to adapt the FIR filter weights (715). The error monitor module monitors the average decision error (720). When it detects that the decision error has reached a minimum, it stops the LMS adaptation process. The FIR filter weight vector is then stored in the target FIR filter weight storage block as the target FIR filter weight vector (725). These target FIR filter weights represent the optimum filter response that essentially compensates for inter-symbol interference distortion caused by any non-optimum received pulse shape characteristics that result from the overall response of the Transmitter/ODC/APD/TIA cascade, exclusive of transmission medium distortion effects (because the transmitter and receiver are connected back-to-back).

Next, the transponders are installed at their respective ends of the transmission medium (730) and the autonomous adaptation process continues as follows. The ODC weight vector can be initialized so that the ODC module's linear-dispersion slope is a value that approximately compensates for the fiber channel's linear dispersion (735). If a priori knowledge of the fiber channel length is not available, the ODC weight vector is initialized so that the ODC module has zero dispersion slope. The FIR filter's center weight is initialized with a single impulse weight and all other weights are set to zero (740). (In some embodiments, the FIR filter weights may be set to the target weights determined earlier.)

The LMS adaptation algorithm is then allowed to adapt the FIR filter weights (745). The error monitor module simultaneously monitors the average decision error (750). When it detects that the average decision error has reached an intermediate minimum (750), it signals the LMS adaptation algorithm to stop the adaptation process and freeze the latest FIR filter weights (755). It also signals the ODC adaptation algorithm to read the current ODC error (760). Based upon this error, the ODC adaptive algorithm then updates the ODC weights incrementally to compensate for the fiber channel dispersion (760). The ODC adaptation algorithm then signals the LMS adaptation algorithm to again adapt the FIR filter weights from their current values. This iterative process of FIR adaptation followed by ODC adaptation may be repeated a number of times, until the ODC adaptive algorithm determines that no further reduction in the ODC error can be made. At this point, the ODC adaptation algorithm freezes the ODC weights, and the ODC and FIR filter weights are maintained as optimum weights (790).

The error monitor module continues to monitor the average decision error. If it detects that the average decision error has deviated significantly from the minimum obtained with the optimum weights, it restarts the adaptive process (775), starting with the current ODC and FIR filter weights. This results in the determination of a new set of optimum weights.

Ideally, the final ODC weights should set the ODC module's linear-dispersion slope to the negative of the fiber channel's linear dispersion slope, and the final FIR filter weights should be equal to the target FIR filter weights. In general, the FIR filter weights may help compensate for any residual linear-delay dispersion.

Like the embodiment described with reference to FIG. 5A, this embodiment takes advantage of both ODC and EDC to provide robust reach extension performance. However, this embodiment has increased complexity relative to FIG. 5A since it requires separate adaptation algorithms for the EDC and ODC modules, as well as interaction between these algorithms. An advantage of the arrangement shown in FIG. 5C is that is can leverage existing EDC implementations that provide access to FIR filter weights. Therefore, it may be possible to implement this embodiment without additional chip development.

Optical transponders incorporating both ODC and EDC signal processing may be superior to EDC-only transponders because the demodulation of an optical signal (e.g by an APD or PIN diode) can lose information present in the phase of the received signal. The ODC corrects some signal dispersion caused by the transmission medium, so the demodulator has an improved input signal to work with. Consequently, the output of the demodulator is cleaner, and subsequent electrical-domain signal processing can be more accurate. In addition, since some embodiments adapt the ODC weights based on an error signal that compares the input and output of a clock/data recovery circuit without reference to the actual user data, they can operate autonomously, based solely on information and signals available within the transponder, without requiring error information from later stages in signal processing.

An embodiment of the invention may be a machine-readable medium having stored thereon instructions which cause a transponder control processor to perform operations as described above. In other embodiments, the opernations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g., a computer), including but not limited to Compact Disc Read-Only Memory (CD-ROMs), Read-Only Memory (ROMs), Random Access Memory (RAM), or Erasable Programmable Read-Only Memory (EPROM).

The applications of the present invention have been described largely by reference to specific examples and in terms of particular allocations of functionality to certain hardware and/or software components. However, those of skill in the art will recognize that an optical dispersion compensation (“ODC”) module can be operated to autonomously adapt to transmission medium conditions by software and hardware that distribute the functions of embodiments of this invention differently than herein described. Such variations and implementations are understood to be captured according to the following claims.

We claim:

1. An apparatus comprising:
an optical dispersion compensator (“ODC”) to perform an adjustable, frequency dependent correction of an optical signal;
a demodulator to convert the optical signal to an electrical signal;
at least one signal analyzer to extract information from the electrical signal; and
a feedback controller to adjust the ODC in response to the information from the at least one signal analyzer.

2. The apparatus of claim 1, further comprising:
an electronic dispersion compensation (“EDC”) module to perform a modification of the electrical signal, the EDC module to emit an error signal for use by the feedback controller.

3. The apparatus of claim 1, further comprising:
a clock/data recovery (“CDR”) unit to recover synchronous data from the electrical signal, the CDR unit to emit an error signal for use by the feedback controller.

4. The apparatus of claim 3, further comprising:
a forward error correction (“FEC”) logic circuit to detect errors in the synchronous data, the FEC logic to emit an error signal for use by the feedback controller.

5. The apparatus of claim 3, further comprising:
a threshold adjustment unit to set a scalar value for the CDR unit, the scalar value to control a discrimination process to distinguish levels of a multi-level signal.

6. A method comprising:
receiving an optical signal carried from a source through a transmission medium;
delaying components of the optical signal by a time that varies according to a light frequency of the optical signal and according to a feedback signal;
converting the optical signal to an electrical signal; and
recovering data from the electrical signal.

7. The method of claim 6, further comprising:
comparing an input and an output of a signal recovery subsystem to produce a decision error estimate; and
incorporating the decision error estimate into the feedback signal.

8. The method of claim 6, further comprising:
filtering the electrical signal with an adjustable filter before extracting data from the signal.

9. The method of claim 8 wherein the adjustable filter is controlled by a second feedback signal.

10. The method of claim 6, further comprising:
applying an error detection and correction algorithm to detect and correct errors in the user data; and
incorporating an error rate indication from the error detection and correction algorithm into the feedback signal.

11. A system comprising:
a transmitter to send user data as a time-varying optical signal;
an optical dispersion compensator (“ODC”) to perform a frequency-dependent variable delay of the optical signal;
a demodulator to convert the optical signal to an electrical signal;
an electronic dispersion compensator (“EDC”) to condition the electrical signal; and
a data recovery unit to extract data from the electrical signal.

12. The system of claim 11, further comprising:
a programmable processor to control the ODC.

13. The system of claim 11, further comprising:
digital interface logic to communicate the user data to a host system.

14. The system of claim 13 wherein the digital interface logic conforms to a Multi-Source Agreement (“MSA”) interface specification.

15. The system of claim 11, further comprising:
a serial interface to receive a control signal from a host system, wherein the control signal indicates an error rate of the data.

16. A computer-readable medium containing instructions to cause a programmable processor to perform operations comprising:
accepting a first signal quality estimate;
changing a delay characteristic of an optical dispersion compensator (“ODC”) device;
accepting a second signal quality estimate; and
adjusting the delay characteristic toward a better quality estimate of the first and second signal quality estimates.

17. The computer-readable medium of claim 16 wherein the signal quality estimates are produced by an analog analysis of an electrical signal.

18. The computer-readable medium of claim 16 wherein the signal quality estimates are produced by an error analysis of a discrete signal.

19. An apparatus comprising:
means for adjusting a propagation delay of an optical signal according to a frequency of the optical signal and an analog control signal;
means for converting the optical signal to an electrical signal;
means for analyzing the electrical signal to produce an error estimate; and
means for generating the analog control signal based on the error estimate.

20. The apparatus of claim 19, further comprising:
means for adjusting the electrical signal according to a second control signal.

21. The apparatus of claim 19, further comprising:
means for recovering synchronous data from the electrical signal.

22. The apparatus of claim 19 wherein the optical signal and the electrical signal carry digital data encoded in an Non-Return to Zero (“NRZ”) encoding.

23. The apparatus of claim 19 wherein the optical signal and the electrical signal carry digital data encoded in a Duo Binary (“DB”) encoding.
